(19) United States
(12) Patent Application Publication
(10) Pub. No.: US 2009/0004346 A1
(43) Pub. Date: Jan. 1, 2009

(54) Continuous vacuum marination apparatus and method

(76) Inventor: Jeremy B. Estes, Russellville, AR (US)

Correspondence Address: WRIGHT, LINDSEY & JENNINGS LLP, 200 WEST CAPITOL AVENUE, SUITE 2300, LITTLE ROCK, AR, 72201-3699, US

(21) Appl. No.: 12/215,301

(22) Filed: Jun. 26, 2008

Related U.S. Application Data
(60) Provisional application No. 60/937,681, filed on Jun. 29, 2007.

(51) Int. Cl. A23B 4/26; A22C 9/00; A23L 1/318

(52) U.S. Cl. 426/281; 99/472

(57) ABSTRACT

An apparatus and method for continuous vacuum marination of a food product. A paddle assembly in a stationary vacuum chamber lifts and tumbles food product in a marinade. The paddles are formed into two subassemblies that are offset to smooth out the load on the paddles and the drive motor. The center about which the paddle assembly rotates is offset from the center of the vacuum chamber to avoid pinching and damaging the food product. The food product is introduced into the vacuum chamber periodically through an airlock type inlet assembly and removed by means of a similar airlock type outlet assembly. The outlet assembly includes an outlet chute for receiving the marinated food product. The outlet chute has a volume which is less than the volume of an internal chamber of the airlock outlet assembly so that closing the door to the outlet airlock door will not damage the food product. The food product is weighed into and out of the vacuum marinator. The rate of cycling of the output is controlled and adjusted based on the input and output weights to maintain a desired retention time of the food product in the vacuum chamber. The vacuum chamber is shaped with a bulge at the top to define a space to accommodate a spray for cleaning the paddles. Also, a cleanout hatch is provided to aid in cleaning the interior of the vacuum chamber.

### CROSS-REFERENCE TO RELATED APPLICATIONS

This application claims the benefit of U.S. Provisional Patent Application No. 60/937,681 filed Jun. 29, 2007, the disclosure of which is incorporated herein in its entirety.

### STATEMENT REGARDING FEDERALLY SPONSORED RESEARCH OR DEVELOPMENT

Not applicable.

### BACKGROUND OF THE INVENTION

1. Field of the Invention

The present invention relates to a method and apparatus for continuous vacuum marination of a food product.

2. Brief Description of the Related Art

In the art of vacuum marination, it is known to employ batch processes where the food product, such as meat, to be marinated is placed into a vacuum chamber which is rotated for a set period of time after which the marinated food product is removed from the vacuum chamber.

Continuous vacuum marinators are also known. For example, U.S. Pat. No. 6,007,418 to Suhner discloses a vacuum tumbler having an evacuatable drum mounted for rotation around its longitudinal axis. The drum is provided on one end with a loading opening and on the other end with a removal opening. For continuous operation, a vacuum sluice is arranged at both the loading opening and the removal opening. A vacuum packing, which is effective when the drum is rotating, is present between the openings and the corresponding vacuum sluice.

### BRIEF SUMMARY OF THE INVENTION

The present invention is an apparatus and method for continuous vacuum marination of a food product. The vacuum chamber is stationary while a paddle assembly within the vacuum chamber lifts and tumbles the food product in the marinade. The paddles are formed into two subassemblies that are offset to smooth out the load on the paddles and the drive motor caused by the paddles lifting the food product. The center about which the paddle assembly rotates is offset from the center of the vacuum chamber to avoid pinching and damaging the food product as it is lifted into the outlet chute.

The food product is introduced into the vacuum chamber periodically through an airlock type inlet assembly with a pair of sliding doors which open and close in sequence to avoid the loss of the vacuum. The marinated food product is removed from the vacuum chamber by means of a similar airlock type outlet assembly. The outlet assembly includes an outlet chute sized and located so that as the paddle lifts the marinated food product some will fall into the outlet chute. The outlet chute holds a quantity of marinated food product until it is periodically dumped through the airlock type outlet assembly. The outlet chute has a volume which is less than the volume of an internal chamber of the airlock outlet assembly so that when the first sliding door to the airlock opens to dump the accumulated marinated food product, there will be sufficient clearance to avoid having the sliding door damage the food product or be rendered inoperable by jamming.

The food product is weighed into and out of the vacuum marinator. The rate of cycling of the output is controlled and adjusted based on the input and output weights to maintain a desired retention time of the food product in the vacuum chamber.

The vacuum chamber is shaped with a bulge at the top to define a space that remains outside the volume swept by the paddles. This space accommodates a spray for cleaning the paddles. Also, a cleanout hatch is provided to aid in cleaning the interior of the vacuum chamber.

These and other features, objects and advantages of the present invention will become better understood from a consideration of the following detailed description of the preferred embodiments and appended claims in conjunction with the drawings as described following.

### BRIEF DESCRIPTION OF THE SEVERAL VIEWS OF THE DRAWINGS

FIG. 1 is a perspective view of an embodiment of the apparatus for continuous vacuum marination of the present invention. The view is from the drive or inlet end.

FIG. 2 is a perspective view of an embodiment of the apparatus for continuous vacuum marination of the present invention. The view is from the outlet end.

FIG. 3 is a block diagram of an embodiment of the method for continuous vacuum marination of the present invention showing the inlet and outlet weighing steps.

FIG. 4 is an elevation view of the outlet end of the vacuum chamber with the outlet end plate removed showing the paddle assembly.

FIG. 5 is a perspective view of the offset paddle subassemblies.

FIG. 6 is an elevation view of the outlet end of the apparatus showing the cleanout hatch.

FIG. 7 is an elevation view of an alternative embodiment of the inlet assembly.

FIG. 8 is an elevation view of an alternative embodiment of the outlet assembly.

### DETAILED DESCRIPTION OF THE INVENTION

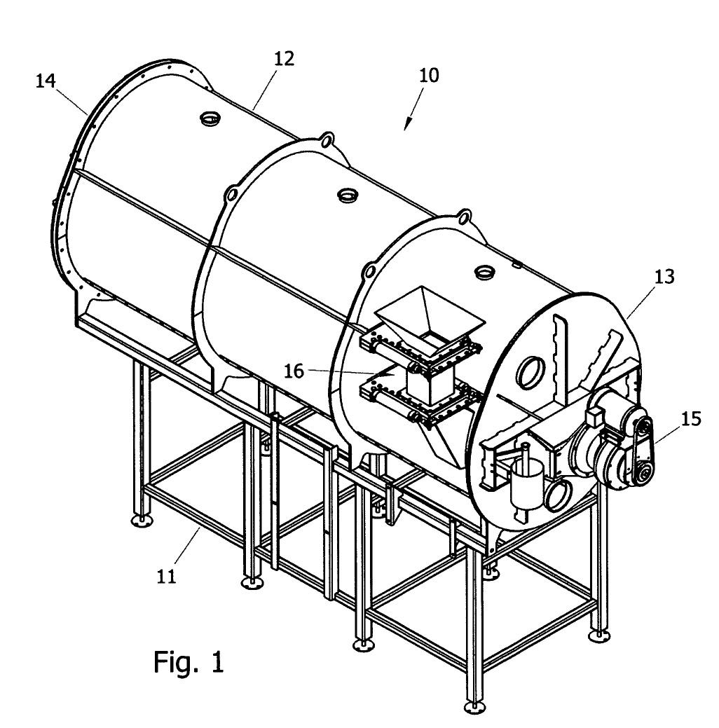

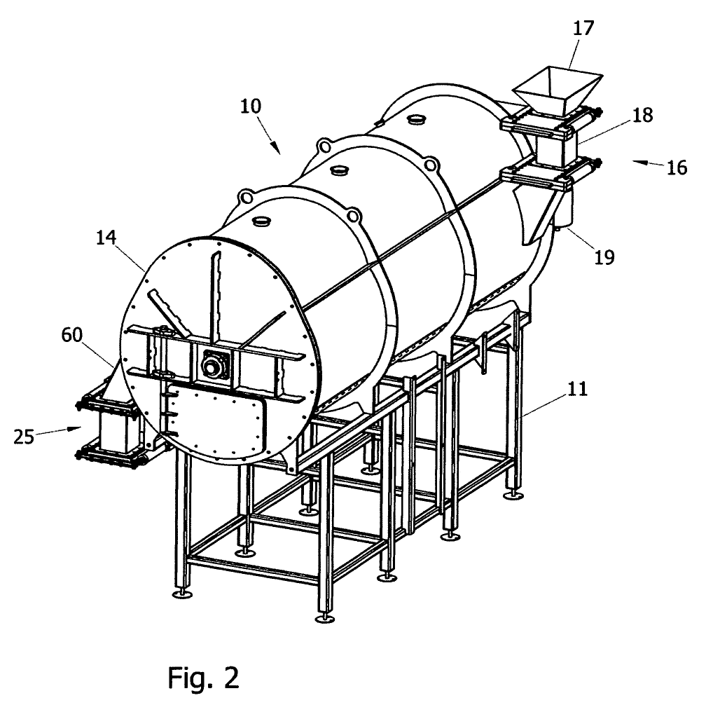

With reference to FIGS. 1 and 2, the vacuum marinator 10 is mounted on a frame 11. The vacuum marinator 10 has a shell 12 closed by inlet end plate 13 and outlet end plate 14 to form a vacuum tight internal chamber 30 for receiving and marinating food products in a marinade under vacuum conditions. The mechanism for maintaining the vacuum is not shown. Any of various means for maintaining a suitable vacuum would be known to those of ordinary skill in the art. A jacket (not shown) around the shell 12 may be provided for cooling. The drive end plate 13 has a drive motor 15 mounted thereon for driving a paddle assembly 40 as described more fully below.

An inlet assembly 16, comprising an inlet hopper 17, an inlet inner chamber 18, an inlet chute 19, a first sliding gate 20 and a second sliding gate 21, as shown in FIGS. 1, 2, and 4, communicates with the internal chamber 30. The inlet hopper 17 receives and guides the food product into the inlet assembly 16. The first sliding gate 20 and the second sliding gate 21 define the entrance and exit, respectively, to the inlet inner chamber 18 and all together form an airlock entry to the internal chamber 30. A quantity of food product, guided by the inlet hopper 17, enters the inlet inner chamber 18 when the first sliding gate 20 is opened. The first sliding gate 20 is then closed before the second sliding gate 21 is opened to the vacuum conditions in the internal chamber 30. The food product in the inlet inner chamber is then discharged into the internal chamber 30 through the inlet chute 19. The motion of the paddle assembly 40 described hereinafter may be timed to avoid being in a position to slice or otherwise damage the food product as it is being discharged into the internal chamber 30.

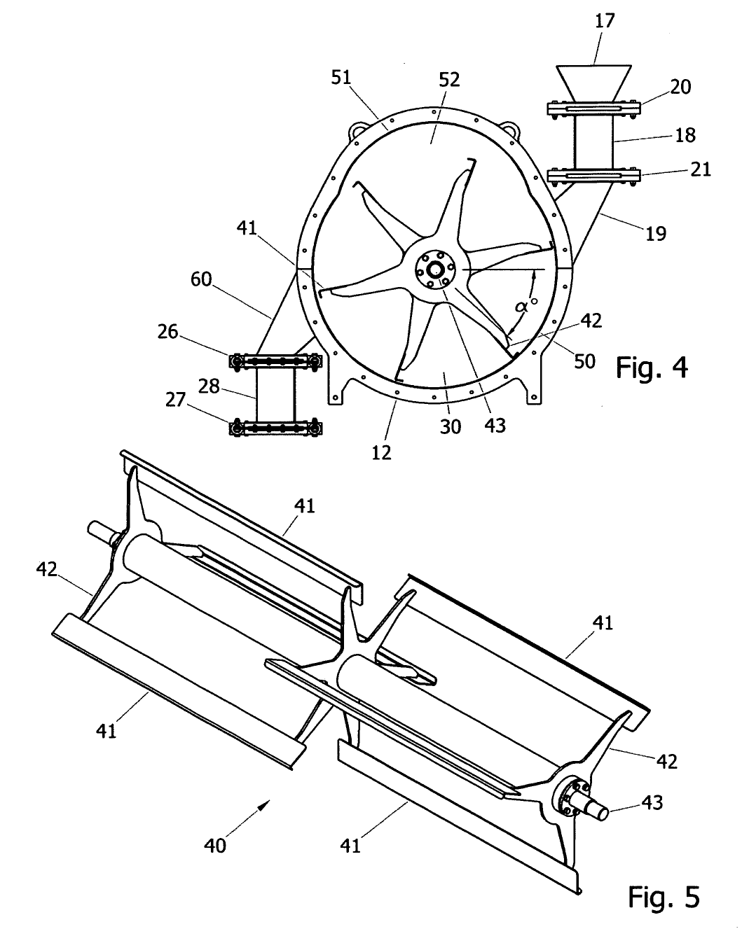

Inside the internal chamber 30, the food product is tumbled in a marinade for a predetermined retention period by a paddle assembly as shown in FIGS. 4 and 5. The paddle assembly 40 comprises a plurality of paddles 41 mounted on paddle supports 42 for rotation about a shaft 43. The shaft 43 is operatively connected to the drive motor 15 for rotation of the paddle assembly 40. It is preferable that the paddle assembly comprises two separate subassemblies of three paddles 41 each as shown in FIG. 5. The three paddles 41 of one subassembly are angularly offset from the three paddles 41 of the other subassembly as shown in the end view of FIG. 4. It will be appreciated that as the paddle assembly 40 is rotated, the food product is picked up and tumbled by each of the paddles 41 in turn. Each time a paddle 41 encounters a concentration of the food product, an increased load is placed on the paddle assembly 40 and in turn an increased load is placed on the drive motor 15. Having the two subassemblies of angularly offset paddles 41, this varying load is advantageously smoothed out.

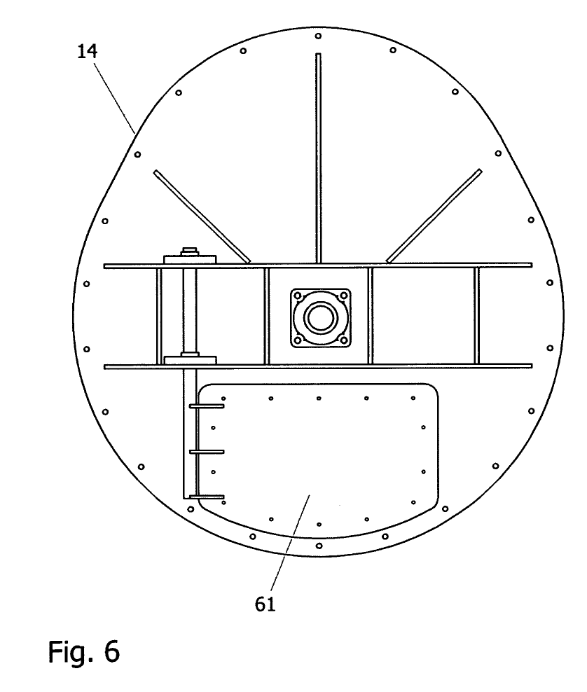

As illustrated by FIG. 4, the internal chamber 30 is preferably not cylindrical in shape. The cross section of the internal chamber 30 comprises a circular arc 50 of approximately 270° of a complete circular arc together with an outwardly bulged section 51. The movement of the outward edges of the paddles 41 closely approximates to the circular arc 50, while leaving a space 52 at the top of the internal chamber 30 that is defined by the outwardly bulged section 51. The space 52 allows one or more sprays (not shown) to be mounted in the inside of the internal chamber 30. By means of the sprays, a clean-in-place (CIP) regimen may be employed to clean the paddles 41. For example, three sprays may desirably be disposed so as to allow cleaning of the full length of the paddles 41. Alternatively, and less desirably, if the cross section of the internal chamber 30 is entirely circular, the two subassemblies of the paddles 41 may be separated by a space to accommodate a spray extending into the internal chamber 30 for cleaning the paddles 41. As shown in FIG. 6, clean out of the internal chamber 30 may also be facilitated by a cleanout hatch 61 in the lower portion of the outlet end plate 14. Alternatively, and less desirably, the entire outlet end plate 14 may be removed for cleaning. The space 52 also allows the inlet to the vacuum system to be located such that the food product and marinade is not sucked into the vacuum system.

As the paddle assembly 40 is rotated within the internal chamber 30, the food product is tumbled in the marinade. To exit the internal chamber 30, an open exit chute 60 is placed on one side of the internal chamber 30 below a horizontal centerline. As the paddles 41 lift the food product, portions of the food product spill into the exit chute 60. The exit chute 60 is part of the outlet assembly 25. The outlet assembly 25 also comprises a first sliding gate 26 and a second sliding gate 27. The first sliding gate 26 and the second sliding gate 27 define the entrance and exit, respectively, to an outlet inner chamber 28, and all together form an airlock exit from the internal chamber 30. A quantity of food product spilled into the outlet chute 60 by the rotating paddles 41 enters the outlet inner chamber 28 when the first sliding gate 26 is opened. The first sliding gate 26 is then closed before the second sliding gate 27 is opened to the atmosphere so that the food product in the outlet inner chamber 28 is discharged. The volume of the outlet chute 60 is less than the volume of the outlet inner chamber 28 so that there is no danger of the food product blocking the closing of the first sliding gate 26 and thereby being subjected to damage by the closing of the first sliding gate 26.

With further reference to FIG. 4, the center of the shaft 43 is preferably not located at the center of the circular arc 50. It is desirable that the outermost edges of the paddles 41 closely approximate the walls of the internal chamber 30 at a point on the side opposite to the exit chute 60 and that all other points in the rotation of the paddle assembly 40, the outermost edges of the paddles 41 should be slightly farther away from the walls of the internal chamber 30. This is achieved by having the center of the shaft 43 mounted approximately ½ inch away from the center of the circular arc 50. The center of the shaft 43 is displaced toward the point on the wall of the internal chamber 30 where the outermost edges of the paddles 41 most closely approach the wall of the internal chamber 30. This point is defined by the angle a shown in FIG. 4. The angle a is preferably about 45° below a horizontal centerline pointed toward side of the vacuum marinator 10 opposite to where the exit chute 60 is located. This slight offset ensures that the outermost edges of the paddles 41 are closest to the wall of the internal chamber 30 where the paddles 41 first make contact with the food product and thereby the food product is less likely to be pinched and damaged throughout the remainder of the period of contact with the paddles 41. Furthermore, by having the outermost edges of the paddles 41 spaced apart from the wall of the internal chamber 30 at all other points, there is less danger of the food product being pinched against the walls of the internal chamber 30, for example at the point where the top of the exit chute 60 meets the wall of the internal chamber.

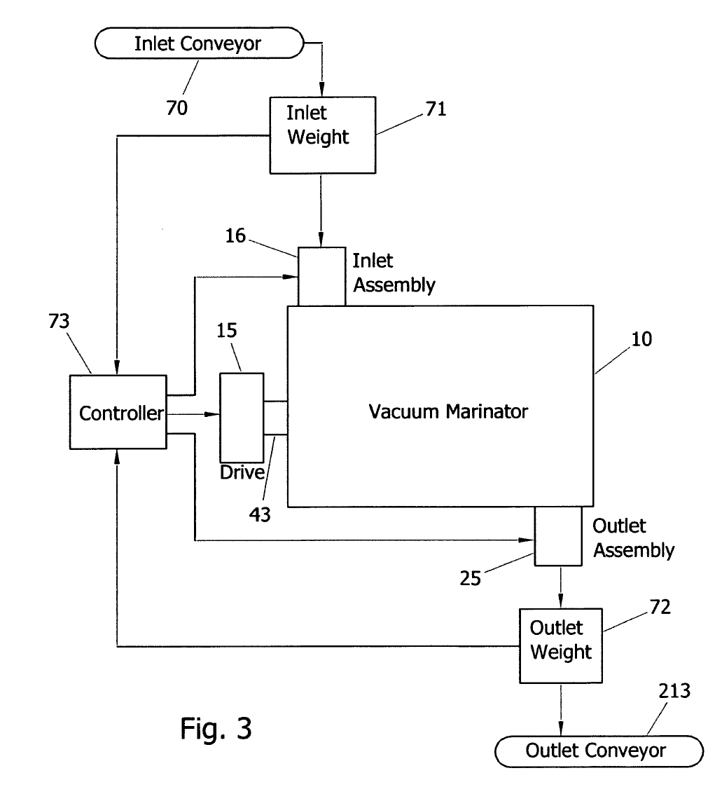

The operation of the vacuum marinator 10 of the present invention may be described with reference to FIG. 3. An input stream of food product is transported to the vacuum marinator 10, for example, by inlet conveyor 70. The input stream is apportioned into a sequence of input batches. The input batches are weighed by an input weighing device 71, which may be any type of weighing device known to those of ordinary skill in the art. Each of the input batches therefore are given an associated weight determined by the input weighing device 71. Each input batch is charged sequentially into the internal chamber 30 through the input assembly 16 as described above. Marinade is charged into the internal chamber 30 based on a predetermined desired ratio of marinade to food product.

The food product is tumbled in the marinade for a period of time, which is desirably a predetermined retention time. The output assembly 25 operates at a predetermined output cycle time. With each cycle of the output assembly 25, a portion of the food product from the internal chamber 30 is discharged into output weighing device 72 to apportion the food product discharged from the internal chamber 30 as a sequence of output batches, each of the output batches having an associated weight determined by the output weighing device 72. The output weighing device 72 may be any type of weighing device known to those of ordinary skill in the art.

The predetermined output cycle time is then adjusted by a controller 73 based on an average of a sequence of input batch weights and an average of a sequence of output batch weights to maintain a given quantity of the food product in the internal chamber 30 for a predetermined retention time. The controller 73 may be any of various types of control devices known to those of ordinary skill in the art, such as a programmable logic controller (PLC). The following example is given to illustrate the operation of the present invention.

Assume that the desired retention time for the food product in the vacuum marinator 10 is 40 minutes and that the vacuum marinator 10 is intended to hold 2000 pounds at any give time. This implies that at a steady state, the input and output rates for the food product would each be an identical 50 pounds per minute. One way of achieving these rates would be for each of the input and output batch weights to be exactly 50 pounds and the input and output cycle times to be 1 minute or 60 seconds each. However, the actual input and output batch weights will vary from the ideal figures. For example, if the input batch weights are 50 pounds each, but the output batch weights drop to 40 pounds each, the amount of food product in the vacuum marinator 10 would begin to rise and the retention time in the vacuum marinator 10 would increase beyond the desired 40 minutes. In order to maintain a steady state condition with 40 pounds of food product in each output batch, the output cycle time must be decreased from 60 seconds to 48 seconds to maintain the same rate of withdrawal of food product from the vacuum marinator 10. If on the other hand, the output batch weight increases to 60 pounds, then the output cycle time must increase from 60 seconds to 72 seconds to maintain a steady state condition.

In reality, both the input and the output batch weights will vary from batch to batch. In order to maintain a steady state condition with the desired retention time, the output cycle time must be constantly varied in response to the variation in the input and output batch weights. To smooth out these variations in input and output batch weights, it is desirable to adjust the output cycle time based on an average of a sequence of input and output batch weights. For example, an average of three consecutive batch weights has been found to be acceptable.

The examples discussed above do not take into account the fact that marinade is added to the vacuum marinator 10 in proportion to the amount of food product introduced into the vacuum marinator 10. For example, the amount of marinade might be set at 15% of the weight of the food product. If 2000 pounds of food product were introduced into the vacuum marinator 10, then the total weight of food product and marinade maintained in the vacuum marinator 10 would be 2300 pounds. If the retention time is selected properly, the marinade will be totally absorbed into the food product during the 40 minute retention period. Therefore, if the input batch weight at a steady state condition is 50 pounds, then the steady state output batch weight would be 1.15×50 pounds or 57.5 pounds. The discussion above would then apply to output batch weights above or below this desired steady state level.

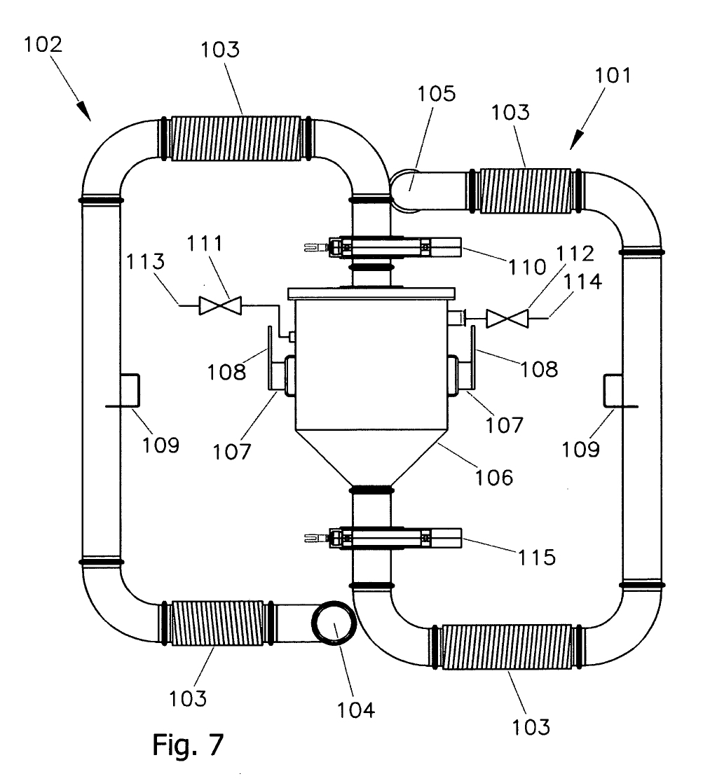

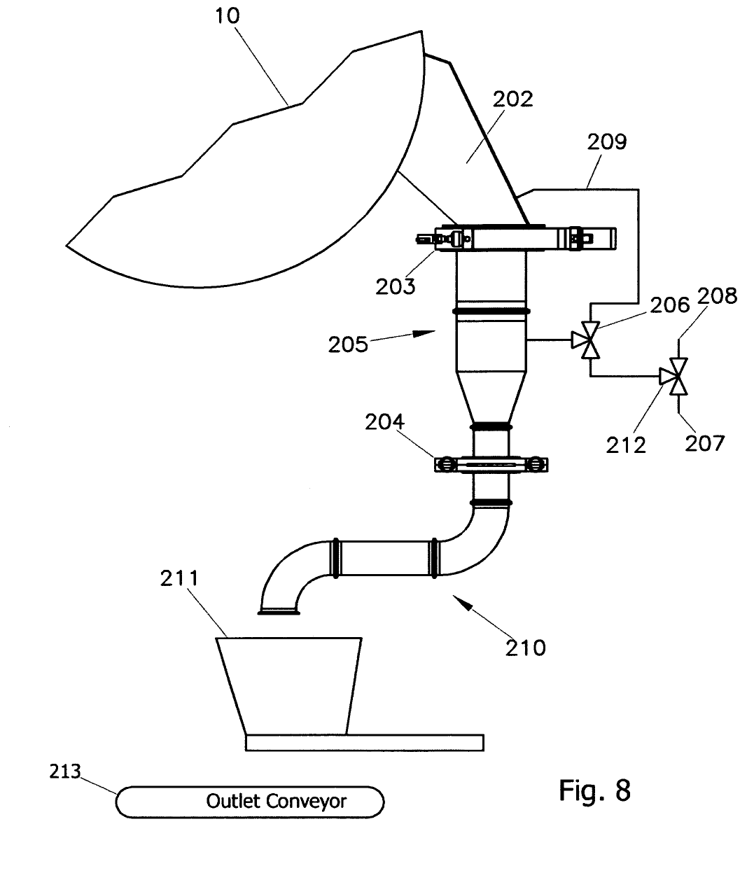

An alternative embodiment of the inlet and outlet assemblies of the vacuum marinator 10 are described with referenced to FIGS. 6 and 7. The alternative embodiment of FIGS. 6 and 7 improves the flow of product and also lowers the height of some of the equipment to make setup, maintenance, and clean-up easier.

The alternative embodiment of the inlet assembly differs from the embodiment described above in that the series of slide gates on top of the vacuum marinator 10 is replaced by an inlet hopper 106 mounted lower on the vacuum marinator 10. The inlet hopper 106 pulls product and marination into it by vacuum, weighs it, and then the product and marination mixture are pulled into the internal chamber 30 of the vacuum marinator 10 by vacuum. The alternative embodiment of the outlet assembly drops product through an upper slide gate 203 into a chamber 205, and then applies pressure to the chamber 205 and opens a lower sliding gate 204 to push the product out of the chamber 205 through piping 210 to a weigh hopper 211 that is located over the belt 213 or other system that is being fed by the vacuum marinator 10.

With reference to FIG. 6, the inlet assembly includes a hopper 106, two slide gate valves 110, 115, inlet piping 102 connected by connection point 104 from an inlet hopper to the hopper 106 and outlet piping 101 from the hopper 106 to the internal chamber 30 of the vacuum marinator 10 through a connection point 105. The inlet and outlet piping 102, 101 are mounted to pipe supports 109 at vertical sections and may be provided with flex hose sections 103. The hopper 106 is provided with a ball valve 111 for marination, and a three-way ball valve 112 for the vacuum/vent operation. The hopper 106 is mounted on mounting brackets 108 via load cells 107 to determine the weight of the product inside it. The ball valves 111, 112 and gate valves 110, 115 are automatically actuated by controller 73 such as a programmable logic controller (PLC) to control the movement of product and marination through the system.

The upper gate valve 110 is connected between the inlet piping 102 and the top of the hopper 106. The hopper 106 is connected at the bottom through the lower gate valve 115 to the outlet piping 101. The flex hose sections 103 isolate the hopper 106 from the vacuum marinator 10 and from the inlet hopper. The flex hose sections 103 also allow the vertical sections of the inlet and outlet piping 102, 101 to be supported on support brackets 109 to carry a portion of the weight of the piping and the weight inside it.

To begin the inlet cycle, the upper gate valve 110 is opened, and the lower gate valve 115 is closed. The three way ball valve 112 is cycled to connect to the vacuum source 114 and the hopper 106 is placed under vacuum. Product then begins to flow from the inlet hopper through the inlet piping 102 to the hopper 106. Once the system detects that the hopper 106 has the desired amount of product in it by sensing the weight, the three-way ball valve 112 is cycled back to vent to the atmosphere, so the vacuum in the hopper 106 is released, and the product stops entering the hopper 106. After a delay to ensure there is no more product entering, the upper gate valve 110 is closed and the system records the weight of the product in the hopper 106. Using this weight, the system calculates how much marination needs to be added based on the desired marination percentage. The marination ball valve 111 is then opened and the marination from the marination source 113 is pumped into the hopper 106 until the desired total weight is reached for the product plus the marination. Once this weight is reached, the marination ball valve 111 is closed and an accurate weight is be recorded. The error in the amount of marination added is recorded and offset to the next batch so the total throughout the day is accurate. After this, the lower gate valve 115 is opened, and since the internal chamber 30 of the vacuum marinator 10 is under vacuum and the hopper 106 is still vented to the atmosphere, the product is sucked from the hopper 106 into the internal chamber 301. This cycle is repeated as often as necessary to keep up with the desired inlet rate.

The outlet system includes upper and lower slide gate valves 203, 204 with a chamber 205 between them. The upper gate valve 203 is large so that product is easily dropped through it, and the lower gate valve 204 is smaller because product is pushed through it with air pressure. Above the upper gate valve 203 is an upper product chamber 202 connected to and open to the internal chamber 30 so that product from the internal chamber 30 falls into and rests on top of the gate in the upper gate valve 203 until it is opened. The upper product chamber 202 is smaller than the chamber 205 so that when the upper gate 203 opens, the product that falls through will not be enough to fill up the chamber 205 and will not get cut by the upper gate 203 when it closes again. The chamber 205 is operable connected to two three-way ball valves 206, 212. By using the ball valves 206, 212, the chamber 205 is attached via a pressure equalization line 209 to the internal chamber 30 of the vacuum marinator 10 in order to pull a vacuum on the chamber 205, to an air pressure source 208, or vented to the atmosphere 207. A weigh hopper 211 at the end of the piping to weigh all product that comes out of the vacuum marinator 10.

To begin the outlet cycle, the ball valves 206, 212 are positioned to connect the chamber 205 to the internal chamber 30 of the vacuum marinator 10 so the pressures are equalized. This allows the product to fall into the chamber 205 when the upper gate valve 203 is opened and pressure will not push it back toward the vacuum marinator 10. The upper gate valve 203 is opened and allows the product to drop through into the chamber 205. Once enough time has elapsed for the product to drop into the chamber 205, the upper slide gate 203 closes. At this time, the lower gate valve 204 opens and the ball valves 206, 212 cycle to put pressure on the chamber 205 from the pressure source 208. This pushes the product out of the chamber 205 and through outlet piping 210 to the weigh hopper 211. The lower slide gate 204 is then closed and the ball valves 206, 212 cycle to allow the chamber 205 to be connected to atmospheric pressure 207. Once enough time has elapsed for the pressure in the chamber 205 to be relieved, the ball valves 206, 212 to cycle to connect the chamber 205 to the internal chamber 30 to equalize the pressures again. The weigh hopper 211 records the weight of the product coming out and repeats this cycle as often as necessary to keep up with the desired outlet rate.

The present invention has been described with reference to certain preferred and alternative embodiments that are intended to be exemplary only and not limiting to the full scope of the present invention as set forth in the appended claims.

What is claimed is:

1. A method for continuous marination of a food product with a marinade in a vacuum chamber, comprising the steps of:
(a) transporting an input stream of the food product to an input weighing device;
(b) apportioning the input stream of the food product into a sequence of input batches, each of said input batches having an associated weight determined by said input weighing device;
(c) charging the input batches into the vacuum chamber;
(d) at a predetermined output cycle time, discharging a portion of the food product from the vacuum chamber into an output weighing device to apportion the food product discharged from the vacuum chamber as a sequence of output batches, each of said output batches having an associated weight determined by said output weighing device; and
(e) adjusting said predetermined output cycle time based on an average of input batch weights and an average of output batch weights to maintain the food product in the vacuum chamber for a predetermined retention time.

2. The method of claim 1, wherein in step (b), said input batches are charged into the vacuum chamber along with a proportionate weight of marinade.

3. An apparatus for continuous vacuum marination of a food product with a marinade, comprising:
an input weighing device;
means for transporting an input stream of the food product to said input weighing device;
a vacuum chamber;
means for charging input batches of the food product into said vacuum chamber from said input weighing device;
an output weighing device;
means for discharging output batches of the food product from said vacuum chamber into said output weighing device at a predetermined output cycle time; and
means for adjusting said predetermined output cycle time based on an average of input batch weights and an average of output batch weights to maintain the food product in the vacuum chamber for a predetermined retention time.

4. The apparatus of claim 3, further comprising means for charging said input batches into said vacuum chamber along with a proportionate weight of marinade.
